(19) United States
(12) Patent Application Publication
(10) Pub. No.: US 2022/0097113 A1
(43) Pub. Date: Mar. 31, 2022

(54) Method for producing a roof rail, extruded profile therefor and roof railing for a vehicle

(71) Applicant: WKW Engineering GmbH, Wuppertal (DE)

(72) Inventors: Andreas Wacker, Solingen (DE); Michael Hoinka, Heiligenhaus (DE); Norman Müller, Velbert (DE)

(21) Appl. No.: 17/643,125

(22) Filed: Dec. 7, 2021

Related U.S. Application Data
(63) Continuation of application No. 15/929,092, filed on Jan. 21, 2019.

(30) Foreign Application Priority Data
Feb. 28, 2018 (DE) 102018104552.2

(51) Int. Cl. B21C 37/04; B60R 9/04; B23C 3/00; F21S 41/148; F21S 41/24; B60Q 1/00

(52) U.S. Cl. CPC B21C 37/045; B60R 9/04; B23C 3/005; F21W 2104/00; F21S 41/24; B60Q 1/0017; F21S 41/148

(57) ABSTRACT

The invention relates to a method for producing a roof rack, to an extruded profile for use in a method of this nature and to a novel roof rack for a vehicle. The novel roof rack for vehicles consists of an extruded profile (1) of aluminum, wherein the rail (13) is formed by a tubular profile part of the extruded profile (1), and the end feet (11, 12) are formed from a bend section of the tubular profile part. The roof rack has different cross-sections in the longitudinal direction, which are created by machining of at least one additional profile web on the extruded profile (1). Freely selectable lateral contours (20, 20′) for a roof rack can be achieved in this way.

The invention relates to a method for producing a roof rack for a vehicle and to an extruded profile for use in such a method.

It is known to attach a roof rack to the roofs of motor vehicles at each of the two longitudinal edges of the vehicle roof. Such a roof rack often consists of a rail extending over the entire length with a constant cross-section and separate feet or adapters to attach the roof rack at its ends to the vehicle roof. A two-footed roof rack is known, as well as a three-footed roof rack or multi-footed roof rack, in which the rail extends at a distance from the vehicle roof when the roof rack is installed on the vehicle roof. Such a spaced-apart rail can also be achieved in a roof rack that consists of a rail and the end feet as a single piece, as is shown in the document WO 95/11144 A1. Furthermore, in addition to a roof rack raised on fixed supports, a roof rack that is surface-mounted on the vehicle roof is known, namely from document DE 20 2014 102,150 Ul, in which the rail and the feet are manufactured from an extruded profile, wherein the end feet are produced by bending, and the foot region or the entire contact surface is processed by milling. The known roof rack produced from the extruded profiles has a constant cross-section over the entire length of the rail, extending partway into the bend region, i.e., the region of the feet. Although a roof rack can be matched to different roof contours by bending the extruded profile, namely through differing bend radii, nonetheless the rail is identical in cross-section for every roof rack that was made from the same extruded profile.

A roof rack is known from document DE 199 48 475 A1 in which a hydroforming of the tubular extruded profile takes place after bending of the extruded profile, and different cross-sections of the extruded profile are produced in this way, especially in the region of the railing feet. Such a hydroforming process is a very expensive process. In such a process, moreover, the material properties of the aluminum material of the roof rack are also changed in the formed regions, and the rail has different wall thicknesses in these formed regions, which is undesirable.

Moreover, the desire exists to provide a roof rack that includes a lighting element, wherein the components for activating the lighting element can be accommodated in the feet so as not to be visible from outside.

The object of the present invention is to provide an improved roof rack that can be manufactured by a simple method.

This object is attained with a method according to claim 1. Advantageous embodiments are described by the dependent claims.

In the novel method according to the invention for producing a novel roof rack, an extruded profile is made from aluminum by extrusion, namely, an extruded profile section with a tubular profile part and with at least one additional profile web on the tubular profile part. The tubular profile part has a hollow space enclosed by profile walls. The additional profile web is connected at its first end to the tubular profile part, and its second, free end projects downward, which is to say is essentially vertical.

After extrusion, a cutting-to-length of the extruded profile section takes place, which is to say a cutting of the extruded profile section into extruded profiles of the desired length for a roof rack, or into a desired preliminary length that is longer than a roof rack to be created so that, in the event of a bending process that may, if applicable, be performed on the cut extruded profile, the ends that are clamped and deformed in the stretch-bending fixture can be removed after the stretch-bending process.

After the cutting-to-length, the cut extruded profiles are subjected to a machining process, namely the additional profile web or the additional profile webs of these extruded profiles are suitably machined to achieve a desired lateral contour. To achieve the desired lateral contour line, the applicable profile web is, in particular, trimmed, wherein the trimming is the same or different over the entire length of the extruded profile, and thus any desired lateral profile line can be created. The trimmed profile web forms this special lateral contour line with its free end along the extruded profile. In the case of different trimming of the profile webs in the longitudinal direction of the extruded profile, different profile cross-sections are created in the longitudinal direction of the extruded profile at the same time. Such machining can be accomplished by milling, stamping, water-jet cutting, laser machining or by other known machining processes. Milling is chosen particularly for the profile webs that are located on the extruded profile such that a sidewall of the tubular profile part of the extruded profile is located behind the profile web to be machined, for example, for profile webs that extend in front of a sidewall of the rail to be created of the roof rack. Here, jet processing would adversely affect the surface of the sidewall.

A bending process may take place before or after the machining, preferably a stretch-bending of the extruded profile. If the bending process takes place before the machining, then the support surfaces of the end feet, or the contact surface of the roof rack in the foot region, or the contact surface over the entire longitudinal orientation of the roof rack can also be machined in addition in accordance with the contour of the motor vehicle roof on which the roof rack is to be installed.

As a result of the machining, any profile web can be trimmed to different degrees in the longitudinal direction of the extruded profile, and a freely selectable lateral contour line can be produced. In one embodiment, a lateral contour line can even be created that extends in a gradual curve into the region of the feet of the roof rack. In particular, the end feet constitute a bend section of the extruded profile. As a result of the machining, a freely selectable lateral contour line, in particular, is produced in the longitudinal direction of the roof rack. In addition to smooth transitions to the end feet, the suggestion of at least one central foot in the region between the end feet can also be provided by leaving regions of the additional profile web untouched.

A prerequisite for the creation of a freely selectable lateral contour line for the roof rack is the special cross-section of the extruded profile made of aluminum that is created in the first step in the method according to the invention, producing a roof rack. This profile shall be described in greater detail below. It consists of a tubular profile part with a hollow space enclosed by profile walls in a known manner. In the finished roof rack, this tubular profile part becomes the rail of the roof rack. Moreover, end feet can be created by bending the tubular profile part. As a special feature, the extruded profile additionally has at least one profile web that is attached at one end (its first end) to the tubular profile part and faces away from the tubular profile part at its second, free end, namely. points downward from the tubular profile part of the extruded profile.

In one embodiment, two such profile webs are provided that project downward from the bottom profile wall of the extruded profile, and form an extension of the sidewalls of the extruded profile, for example. Such an extruded profile has two parallel or nearly parallel foot-like profile webs.

In one special embodiment, a first profile web is provided as a downward extension of a side profile wall of the extruded profile, namely the first sidewall, which constitutes the inner side in the completed and installed roof rack. Another profile web is located in front of the second, lateral profile wall, which delimits the hollow space toward the outside in the installed roof rack. A second such profile web extends downward at the outside, nearly parallel to the second sidewall, wherein a separation is provided between this profile web and the second sidewall. The second sidewall and the profile web form a groove that is open toward the bottom. This groove has the special advantage that a sufficient working space is available during machining of this profile web without the surface of the second sidewall located behind it being damaged. A profile web of this nature can advantageously also partially conceal a passage for a lighting element. In this case, the passage, which is open toward the bottom and extends in the longitudinal direction of the extruded profile, is located at the second sidewall and preferably is located at the upper end of the groove formed between the second sidewall and the profile web. In such an embodiment, it is possible, in particular, for the connection region of the lighting element, with the components for activating the lighting element, that can be provided in the region of the end foot to also be covered completely by the profile web.

In another advantageous embodiment for producing a roof rack, in particular a surface-mounted roof rack, only the last-described, second profile web that is located in front of the second sidewall is provided.

In all the above-described embodiments of the novel extruded aluminum profile for producing a roof rack, the additional profile web or additional profile webs serve, in particular, to create different cross-sections in the longitudinal direction of the rail and thereby to achieve a freely selectable lateral contour for the roof rack, wherein roof racks that look different can be created from one extruded profile.

The roof rack for vehicles produced by means of the novel method consists, in a known manner, of a rail and end feet. The connection to a vehicle roof takes place in the region of the end feet, either indirectly, e.g., through adapters, or directly, e.g., through a screw joint. The rail and the feet of the roof rack are designed as a single piece and are made from the extruded aluminum profile, namely from an extruded profile that has at least one profile web in addition to the tubular profile, wherein the rail is composed of the tubular profile part of the extruded profile, wherein the end feet are composed of a bend section of the tubular profile part, and wherein the rail advantageously has different cross-sections in the longitudinal direction, and these different cross-sections are created by machining of the profile webs that are additionally present on the extruded profile. This means that different lateral contour lines on a roof rack can be created from one extruded profile, especially on the outer side of the roof rack installed on the vehicle roof. The roof rack can be a surface-mounted roof rack, or a roof rack in which the rail extends at a distance from the vehicle roof and the roof rack constitutes a roof rack raised on fixed supports. In an especially advantageous manner, the roof rack can also include a lighting element that is accommodated in an open passage extending in the longitudinal direction of the profile. In this case, the freely selectable machining of the additional profile web achieves a lateral contour line that extends in front of the second sidewall at which the passage is provided and that, on the one hand, can influence the direction of radiation of the lighting element, and, on the other hand, covers the lighting element's connection region with the components for activating the lighting element from the outside.

Exemplary embodiments are described below on the basis of the drawings in order to explain the invention. The drawings show:

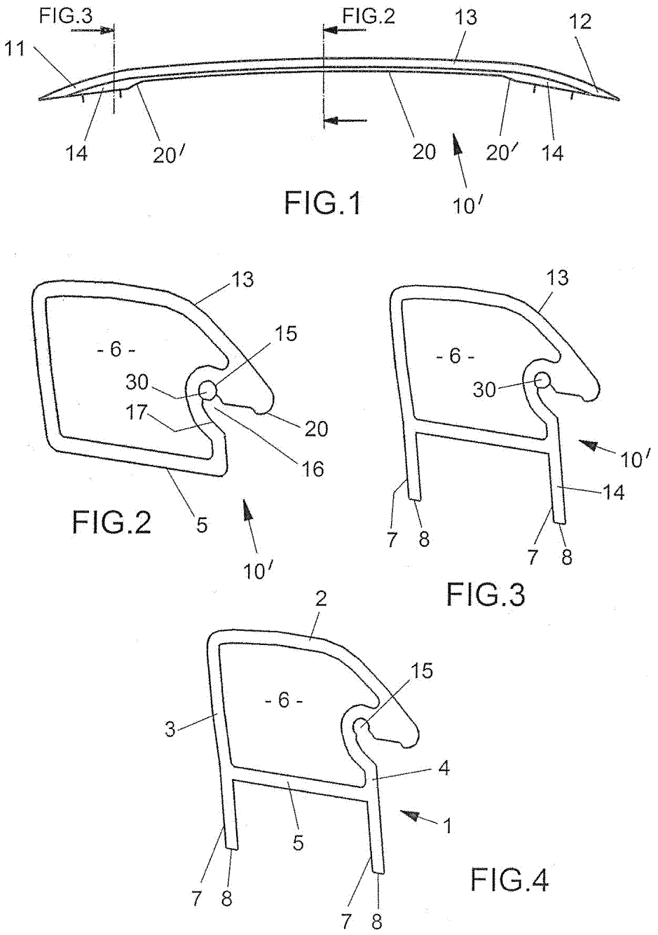

FIG. 1 a view of a two-footed roof rack according to the invention,

FIG. 2 a cross-section through the roof rack from FIG. 1,

FIG. 3 another cross-section through the roof rack from FIG. 1,

FIG. 4 a cross-section through the extruded profile from which the roof rack according to FIG. 1 was made,

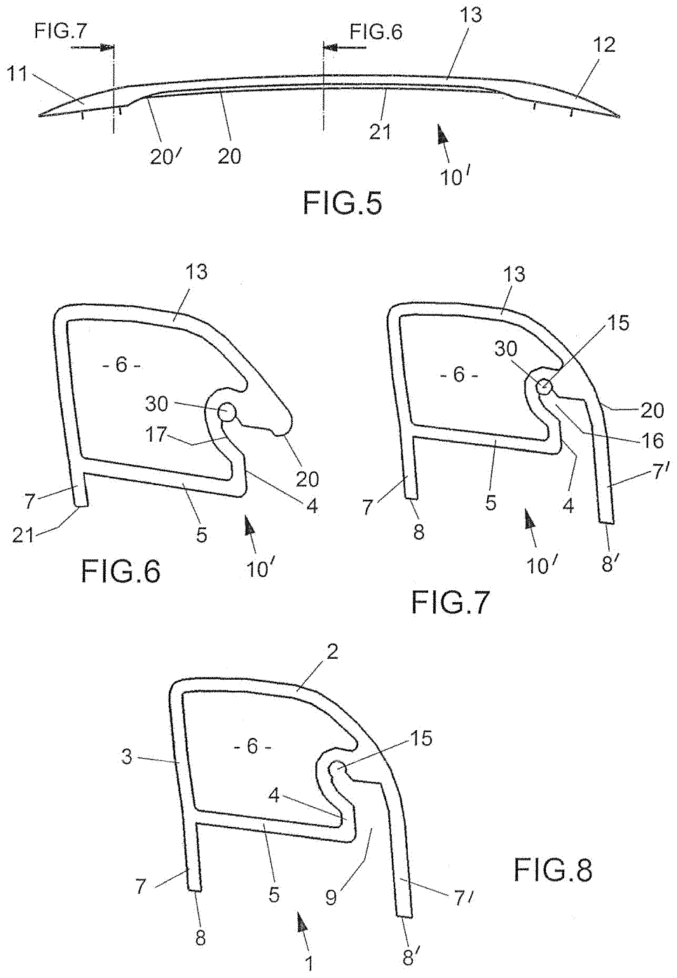

FIG. 5 a view of a two-footed roof rack according to the invention,

FIG. 6 a cross-section through the roof rack from FIG. 5,

FIG. 7 another cross-section through the roof rack from FIG. 5,

FIG. 8 a cross-section through the extruded profile from which the roof rack according to FIG. 5 was made,

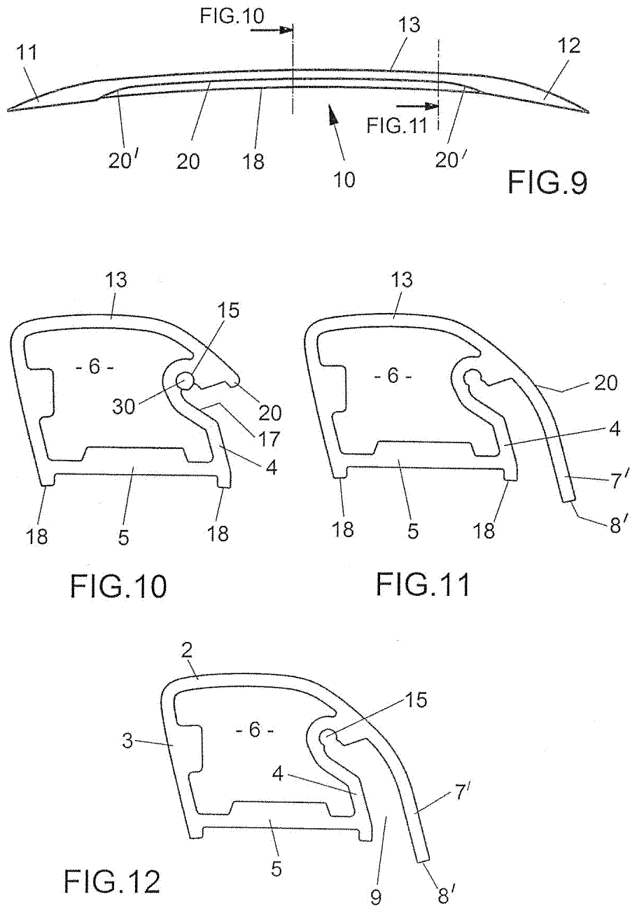

FIG. 9 a perspective view of a surface-mounted roof rack according to the invention,

FIG. 10 a cross-section through the roof rack from FIG. 9,

FIG. 11 a cross-section through the roof rack from FIG. 9,

FIG. 12 a cross-section through the extruded profile from which the roof rack according to FIG. 9 was made,

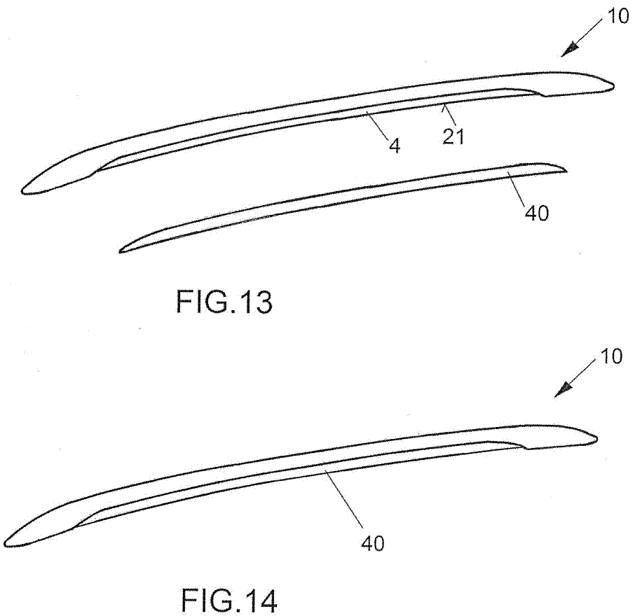

FIG. 13 a view of a two-footed roof rack according to the invention with an insert prior to installation,

FIG. 14 a view of a two-footed roof rack according to the invention with an insert.

For the different embodiments of a roof rack shown in FIG. 1, FIG. 5, FIG. 9 and FIG. 14, identical reference symbols are used for comparable parts of the different embodiments.

A first embodiment of a roof rack 10′ produced in accordance with the invention is shown in FIG. 1. A roof rack 10′ of this type is installed on the vehicle roof on the left-hand and right-hand longitudinal sides. This roof rack 10′ consists of a rail 13 extending in the longitudinal direction and end feet 11, 12, wherein the rail 13 and the feet 11, 12 are implemented as a single piece and are produced from an extruded profile 1 made of aluminum. A cross-section of the extruded profile is shown in FIG. 4. As a result of the extrusion, an extruded profile section with a constant cross-section is produced, namely, a tubular profile part with a hollow space 6 enclosed by profile walls 2, 3, 4, 5, wherein one profile wall 5 constitutes the bottom and delimits the hollow space 6 at the bottom. Two profile webs 7 extend downward from this bottom profile wall 5. The profile webs 7 are attached to the tubular profile part at their first ends, and their free ends 8 point downward, i.e. away from the bottom profile wall 5. In the example from FIG. 4, these profile webs 7 constitute an extension of the first sidewall 3 and of the second sidewall 4. The sidewall 4 faces the outside when the roof rack 10′ is installed on a roof of a vehicle. To create the roof rack 10′ in accordance with FIG. 1, an extruded profile 1 in an appropriate length is cut from the profile section created by extrusion. Next, the extruded profile 1 is stretch bent, wherein the bend sections form the end feet 11, 12. These bend sections are then machined to obtain the desired support surface of the feet 11, 12 for the two-footed roof rack 10′ shown in FIG. 1. The machining in this case also includes milling of the profile webs 7. The profile webs 7 have been completely removed from the extruded profile 1 in the central lengthwise region of the roof rack, the region of the rail 13, as can be seen in the cross-section from FIG. 2. In contrast, the profile webs 7 are completely retained in the transition region to the feet 11, 12, shown in FIG. 3. In the novel roof rack 10′, the milled edge obtained by the milling of the profile webs 7 constitutes a lateral contour line 20 that is gradually curved at its respective ends 20′ and thus forms a smooth transition to the feet 11, 12.

In addition, on the extruded profile shown in FIG. 2, a passage 15 that is open to the outside for a lighting element 30 is provided on the second lateral profile wall 4. The passage opening 16 is constricted somewhat, so the lighting element 30 is pushed in for installation and is held in the passage 15 by the constriction of the passage opening 16. The lighting element 30 extends over the entire longitudinal extent of the roof rack 10′ and is connected to components for activating the lighting element 30 in the region of the end feet 11, 12. If this is an optical waveguide, for example, the light for the optical waveguide is fed in by means of light-emitting diodes that are located in the hollow space 6 of the feet 11, 12. Moreover, other lighting elements are also possible. In advantageous manner, the light from the lighting element 30 is reflected at the reflecting surface 17 on the second lateral profile wall 4, and, in this way, is radiated outward. The connection region—between the lighting element 30 and the components for activating the lighting element 30—is covered by the profile web 7 in the foot transition region 14 to the feet 11, 12.

FIG. 5 shows another roof rack 10′ produced in accordance with the invention, namely, a two-footed roof rack with end feet 11, 12 and a rail 13 located therebetween, wherein the rail 13 is implemented as a single piece with the feet 11, 12 and is produced from an extruded profile made of aluminum in this case as well. The extruded profile, which is shown in FIG. 8, has been cut from the extruded section. It likewise comprises a tubular profile part with a hollow space 6 enclosed by profile walls 2, 3, 4, 5. In this case, an additional profile web 7 is present as an extension of the first sidewall 3. This profile web 7 projects downward from the profile wall 5 that forms the bottom. In contrast to the embodiment from FIG. 4, the second additional profile web 7′ does not project as an extension of the second profile wall 4, but instead extends perpendicularly downward from the top profile wall 2, and thus is located in front of the second sidewall 4. The profile web 7′ likewise extends downward approximately parallel to the profile web 7. The sidewall 4 and the profile web 7′ form a groove 9 that is open at the bottom, at the top end of which is located a passage 15 for a lighting element 30. The passage 15 extends in the longitudinal direction of the extruded profile 1 and in the longitudinal direction of the roof rack 10′.

Different embodiments of a roof rack can be created from this extruded profile 1 from FIG. 8, for example, the roof rack 10′ shown in FIG. 5. The central region of the rail 13 of this roof rack 10′ has a cross-section shown in FIG. 6. Here, the profile web 7 with its original free end 8 was substantially trimmed by the machining, resulting in a lateral contour line 21 in the longitudinal direction of the roof rack 10′. The other profile web 7′, which covers the second sidewall 4, was trimmed to a significantly greater extent, resulting in a lateral contour line 20. This lateral contour line 20 likewise extends in a gradual curve in the transition to the end feet 11, 12, as is shown for 20′. Moreover, it would also be possible to leave the profile webs 7, 7′ untouched in the central longitudinal region of the roof rack 10′ so that a center foot is suggested and the roof rack has the appearance of a three-footed roof rack.

FIG. 9 shows another embodiment of a roof rack 10 according to the invention. In this case, it is a surface-mounted roof rack, i.e., the installed roof rack 10 rests over its entire length against the roof of a motor vehicle. As is evident from FIGS. 10 and 11, the contact surface is formed by the left and right contact webs 18 provided on the bottom 5 in the longitudinal direction of the roof rack 10, so a contact seal can be additionally provided under the profile wall 5. The roof rack 10 shown in FIG. 9 has been made from an extruded profile 1 according to FIG. 12. Once again, the extruded profile 1 consists of a tubular profile part with profile walls 2, 3, 4 and 5 that enclose a hollow space 6. In this case, the extruded profile has only one profile web 7′. This profile web is located in front of the second sidewall 4, namely, the sidewall 4 that constitutes the outer side when the roof rack 10 is installed. One end of the additional profile web 7′ is attached to the tubular profile part. The free end 8′ of the profile web 7′ faces downward. This profile web 7′ completely covers the second sidewall 4 in the region of the feet 11, 12, as the cross-section from FIG. 11 shows, whereas, in contrast, this profile web 7′ is almost completely removed, and the milled edge forms a lateral contour line 20 that allows the sidewall to be visible, in the central longitudinal region of the roof rack 10, in the region of the rail 13, shown in FIG. 10. Here too, a smooth transition of the lateral contour line 20 to the end feet 11, 12 is formed in the transition region 20′.

This sidewall 4 once again includes a passage 15 extending in the longitudinal direction of the extruded profile 1 for a lighting element 30. In a surface-mounted roof rack 10, the passage 15 ends nearly at the roof surface after the bending of the feet 11, 12 and the machining of the contact surface. In order to be able to route the lighting element 30 in the hollow space 6 of a foot 11, 12, a transition between the passage 15 and the hollow space 6 must be created during the machining, for example, in the form of milled recesses in one of the walls that enclose the hollow space 6. In this process, it is taken into account that a lighting element 30, for example, an optical waveguide, must not be kinked, but instead is routed in the hollow space 6 in as large a curve as possible, and connected there to the components for activating the lighting element 30. Here too, the connection region between the lighting element 30 and the components for activating the lighting element 30 is covered by the profile web 7′ in the transition to the feet 11, 12.

FIGS. 13 and 14 show that a special colored design can also be achieved in a simple manner in addition to a freely selectable lateral contour line, for example by means of an insert 40 that is attached to the machined extruded profile to form a two-color roof rack 10′, shown in FIG. 14. In this case, the insert 40 can be a flat part made of plastic or aluminum. This insert 40 is colored in a special manner, for example as a colored or painted or film-covered aluminum sheet. The machined roof rack profile 10′ is anodically oxidized and, if applicable, colored. An attachment between the roof rack profile 10′ and the insert 40 can be achieved in the simplest way by an adhesive attachment, clamped attachment, or clip attachment. In this design, a receptacle for the insert 40 has been produced on the roof rack profile 10′ by the machining. This insert 40 can in particular cover the sidewall 4 completely, but also only partially if applicable.

A simple method for producing a roof rack 10, 10′ is provided, wherein in advantageous manner, different lateral contour lines for a roof rack 10, 10′ are possible from one extruded profile by means of the machining of the profile webs 7, 7′, and, thus, a novel roof rack with a variable cross-section in the longitudinal direction of the rail 13 can be created. By retention of the profile webs 7, 7′ in the transition region between the rail 13 and the end feet 11, 12, sufficient space is created for the lighting element 30 to extend into the hollow space 6 in the region of the feet 11, 12 without the connection region between the lighting element 30 and the components for activating the lighting element 30 being visible from outside. In this design, the lateral contour line 20 can be matched to the contour of the vehicle roof, or can be freely selected according to the wishes of the motor vehicle manufacturer, and, for example, can also be designed such that an appropriately available receptacle is created on the roof rack for an insert 40 for a two-color design of the roof rack. The different possible side views of a roof rack that are made possible by this means are achieved by a simple method, without the material of the tubular profile part that forms the rail 13 and the end feet 11, 12 suffering adverse effects as a result of a forming process. The machining to create variable cross-sections is carried out solely on a profile web 7, 7′ that is provided outside the tubular profile part. The tubular profile part has profile walls 2, 3, 4, 5 with constant wall thickness in the longitudinal direction of the rail 13 so that the machining to achieve a differently designed roof rack 10, 10′ has no effect on the strength of the roof rack 10, 10′.

### LIST OF REFERENCE SYMBOLS

1 extruded profile
2 profile wall, top
3 profile wall, sidewall
4 profile wall, sidewall, outer side
5 profile wall, bottom
6 hollow space
7, 7′ profile web
8, 8′ free end of 7, 7′
9 groove
10, 10′ roof rack
11 front foot
12 rear foot
13 rail
14 foot transition region
15 passage (concealed)
16 passage opening
17 reflecting surface
18 contact webs
20 lateral contour line, milled edge
20′ ends of 20
21 lateral contour line, milled edge
30 lighting element
40 insert

1. Method for producing a roof rack (10, 10′) comprising the steps:
producing an extruded profile section from aluminum, consisting of a tubular profile part with a hollow space (6) enclosed by profile walls (2, 3, 4, 5) and additionally consisting of at least one profile web (7, 7′) that is connected at one end to the tubular profile part and faces downward with its other, free end (8),
in which the profile web (7′) in front of a lateral profile wall (4) and forms with this profile wall (4) a groove (9) that is open toward the bottom,
in which at the top end of the groove (9) is located a passage (15) extending in the longitudinal direction of the tubular profile and open toward the outside,
cutting extruded profiles (1) of a desired length from the extruded profile section (1),
creating a desired lateral contour line (9) on the extruded profiles (1) by machining of the at least one profile web (7, 7′) that are present.

2. Method according to claim 1, characterized in that the extruded profile section is produced with the profile web (7′) and a second profile web (7), that the second profile web (7, 7′) is an extension of another lateral profile wall (3).

3. Method according to claim 1, characterized in that the extruded profile (1) is bent before the machining in order to match a specified roof contour of a motor vehicle.

4. Method according to claim 3, characterized in that a contact surface is additionally created by means of the machining.

5. Method according to claim 3, characterized in that the machining is performed by milling, stamping, water-jet cutting, or laser machining.

6. Method according to claim 1, characterized in that a receptacle suitable for an insert (40) created on the extruded profiles (1) by the machining.

7. Method according to claim 1, characterized in that a lateral contour line that includes a center foot is created on the extruded profiles (1) by the machining.

8. Method according to claim 1 or 3, characterized in that the extruded profile (1) is bent after the machining in order to match a specified roof contour of a motor vehicle.

9. Roof rack for motor vehicles, consisting of a rail (13) and end feet (11, 12) that can be attached to a motor vehicle roof, wherein the rail (13) and the feet (11, 12) are designed as a single piece and are made from an extruded profile (1) of aluminum according to one of claims 1 to 8, wherein the rail (13) is composed of a tubular profile part of the extruded profile (1), wherein the end feet (11, 12) are composed of a bend section of the tubular profile part, wherein the rail (13) has different cross-sections in the longitudinal direction, characterized in that the different cross-sections are created by machining of at least one additional profile web (7, 7′) on the extruded profile (1), and wherein a freely selectable lateral contour line is formed by the machined profile web (7, 7′).

9. Roof rack according to claim 9, characterized in that the rail (13) and the feet (11, 12) constitute a surface-mounted roof rack (10).

10. Roof rack according to claim 9, characterized in that the feet (11, 12) and the rail (13) constitute a roof rack (10′) raised on fixed supports.

11. Roof rack according to claim 9, characterized in that the rail (13) has a passage (15) extending in the longitudinal direction of the profile for a lighting element (30), and this passage (15) terminates in the end feet (11, 12), and components for activating the lighting element (30) are accommodated in a hollow space in the feet (11, 12), wherein the connection point of the lighting element (30) with the components for activation is covered by the profile web (7, 7′).
